(19) United States
(12) Patent Application Publication
(10) Pub. No.: US 2008/0221920 A1
(43) Pub. Date: Sep. 11, 2008

(54) Personal Transportable Healthcare Data Base Improvements

(76) Inventor: Douglas Lee Courtney, Palm Coast, FL (US)

Correspondence Address: JOEL I ROSENBLATT, 445 11TH AVENUE, INDIALANTIC, FL, 32903, US

(21) Appl. No.: 11/684,115

(22) Filed: Mar. 9, 2007

(51) Int. Cl. G06Q 50/00

(52) U.S. Cl. 705/2

(57) ABSTRACT

This is an improvement to the patient data base disclosed in Published Patent Application No. US 2007-0055550 A1, Published Mar. 8^{th}, 2007, incorporating separate image files, a virtual portal for importing and exporting data base records to an or from an EMR and, dental records.

### CROSS REFERENCE TO RELATED APPLICATIONS

This application incorporates by reference Patent Publication No. US 2007-0055550 A1, Published Mar. 8-, 2007.

### BACKGROUND

Healthcare data bases are used widely, particularly in the offices of healthcare practitioners, requiring an electronic medical record system capable of separately storing the records of multiple patients, or of accessing a central store, for reading the current healthcare facts of widely dispersed patients or for revision of those records.

While central data bases can be used efficiently, particularly where a patient may require medical treatment at a location away from home, there is a need to have an up to date and current data base, wherever the patient may be and whenever there is an urgent need for immediate or prompt access to patient healthcare facts needed for immediate diagnosis or treatment.

However, a personal transportable healthcare data base, providing immediate access to current patient records, should be usable by the patient or the practitioner, to identify and enter the various specific healthcare faces for a patient, within a related general healthcare classification. The data base process should have a notice or warning system for identifying conflicts or problems with new and existing treatments or prescriptions.

To be efficient, the data base should include a bar code system that stores a library of easily accessibly healthcare facts, for example, medications, surgeries, allergies, for selection and bar code entry of the related data into the data base.

Provisions should be made for direct entry of specific healthcare facts by a doctor into the patient data base or for import or export, of patient data between a patient and the practitioner's electronic medical record data base system.

Summary Patient Practitioners™, and iPHER™ are trademarks of Patent Practitioners, LLC, a corporation of the State of Florida.

Problems of patient healthcare data base systems are solved by invention described in a preferred embodiment in the related Patent Publication No. US 2007-0055550 AI, Published Mar. 8^{th}, 2007, incorporated by reference.

The related Patent Publication No. US 2007-0055550 AI, shows in a preferred embodiment a personal transportable healthcare data base record comprises a personal portable patient healthcare data base program, which may be stored in a computer hard drive or on a magnetic, optical, or other suitable medium for storing data. While it may be stored on a centralized store, the advantage of the invention is in a portable transportable data base that can be everywhere the patient may be and which may be presented to a practitioner or exported into the practitioner electronic medical record (“EMR”), as the patient's current medical information, as may be required for immediate treatment.

In a preferred embodiment the database is arranged in relatable data base records, as would be known to those skilled in the art. In a preferred embodiment, the data is stored in relatable tables, as is understood by those skilled in the art. The data base program may comprise a data input and output process, for example, as would be known in a windows computer operating display system, a data insertion display and a data output process comprising a data output display

However, as would be understood by those skilled in the art, any other data input or output process may be used, as shown in a preferred embodiment, for the insertion of specific healthcare facts, within respective general healthcare classifications or for the insertion of bar codes representing specific healthcare facts or the names of the specific health care facts, which is now known or hereafter developed without departing from the disclosed inventive principles.

In a preferred embodiment according to the disclosed inventive principles, the data base program may use a bar code to represent healthcare facts. The bar coded healthcare facts may comprise a plurality of specific healthcare facts, within respective general healthcare facts. In a preferred embodiment, for example, within the general healthcare facts of medications and prescriptions, a listing may be presented as a scrollable listing, of the specific healthcare facts of medications and prescriptions, available for prescription, or which have been prescribed. The listing may be of the specific healthcare facts and the corresponding bar codes, and may be presented in a scrollable listing, as would be understood by those skilled in the art. In a preferred embodiment, for a specific healthcare fact, there is a matching bar code number, which may be scanned for placing the bar coded information in the data base, or may be typed into the bar code data insertion window or may be inserted by highlighting the selected bar code and selecting the highlighted bar code for insertion into the data base for the general healthcare classification table. When inserted in a data record, the specific healthcare fact may be displayed and printed.

Other general health care classifications, as shown for a preferred embodiment, are for compounds or supplements, surgical procedures, laboratory procedures, x-ray procedures, and miscellaneous medical procedures. However, other general healthcare classifications may be added without departing from the disclosed inventive principles.

As shown in a preferred embodiment, in Patent Publication No. US 2007-0055550 AI, the data base comprises bar coded healthcare facts comprising specific healthcare facts within respective general healthcare classifications and may be a universal or a proprietary code. In a preferred embodiment, the bar code may be in a seven position code with the general healthcare classification in the most signification position. For example, Medications and Prescriptions may be coded by a “1”, Surgical Procedures by a “4,” Laboratory Procedures by a “3,” X-Ray Procedures by a “5,” Miscellaneous Medical Procedures by “2,” the doctor's or physician's diagnosis by a “6,” and wherein other general healthcare classifications identified by other numerals or codes, as would be understood by those skilled in the art, may be used without departing from the disclosed inventive principles.

As shown in a preferred embodiment, the data process or program for entering and displaying data and for arranging the data within a set of related data tables, within the data base, comprises a process for placing in at least one of the relatable records which is identified with a respective general healthcare classification, a specific healthcare fact corresponding to a respective bar code. In a preferred embodiment, the bar code for specific healthcare facts would be coded for the respective general healthcare classification.

In a preferred embodiment, as shown in Patent Publication No. US 2007-0055550 AI, the data base data input process may identify from a listing, a bar code for a specific healthcare fact entered in a data insertion display or a specific healthcare fact for a bar code entered in a data insertion display.

The displays for identifying the bar code from the specific healthcare fact or the specific healthcare fact from the bar code may be separate from the process for entering the specific healthcare fact into the data base records by entering the respective bar code in a bar code insertion display. As would be understood by one skilled in the art, the data entry may be by highlighting the selected specific healthcare fact or bar code, from a listing of healthcare facts and selecting the highlighted bar code or specific health care fact for entry into the respective general healthcare classification table. As would be understood by one skilled in the art, the listing may be a scrollable listing.

In the disclosed inventive principles, as shown in a preferred embodiment, the input process may comprise a display or screen with a list of a plurality of specific health care facts within or with respect to a general healthcare classification. The listing, as shown in preferred embodiment, may be in scroll down list as would be understood by those skilled in the art, wherein a patient or a practitioner, may select from the specific healthcare fact or bar code, as presented in the display or screen.

In a preferred embodiment, the specific healthcare facts, as may be arranged in respective general healthcare facts, may be presented in a report in a data output display or screen and may include the respective graphic bar code. The data base may comprise a process for printing the displayed report with the graphic and numeric respective bar code. The printed report may be used, as described in a preferred embodiment, for inserting the bar code information by bar coded scanning or by insertion of the bar coded value.

In a preferred embodiment, the scanned bar code for a specific healthcare fact, may be inserted through by means of, the input display for the corresponding general healthcare fact. As shown in a preferred embodiment, a data insertion display may comprise at least one data input display for a respective general healthcare classification, the process presenting a plurality of bar coded specific healthcare facts for said respective general healthcare classification, and with insertion of the correct bar code for a specific healthcare fact as may be selected from the plurality of bar codes and corresponding healthcare facts, into the bar code insertion display or from a scanned bar code.

In the disclosed inventive principles, as shown for a preferred embodiment in Patent Publication No. No. US 2007-0055550 AI, at least one data output display includes a plurality of navigation points and a data process opening a respective output display for a general healthcare fact corresponding to at least of the navigation points. In this process, navigation from one data output display for one respective general healthcare fact, to one or more other general healthcare facts, is provided.

One of the navigation points presented in an data output display, may be to a patient information input display or screen, as shown in a preferred embodiment with a process for inserting graphic images into relatable records. Generally, the graphic images may be produced by a physiological exposure to electrical, light, or magnetic, waves, or sound wave, comprising exposure to x-rays or from an analysis of biological material, as would be understood by those skilled in the art. The graphic image may be a picture of the patient or the DNA analysis of the patient, for example.

As shown in a preferred embodiment, there is a main page or screen, for displaying general information about the patient, comprising the patient's name, contact information, the primary care physician, and the physician's contact information, and specific healthcare facts, which are necessary or desirable in an emergency or urgent situation. As shown in preferred embodiment, the main page may comprise information of the patient's current medical condition, recent surgeries, recent out of country visits, and may include navigation points to a patient input information display, a doctor's or practitioner's input display, and to data output displays for allergies, x-rays, current medical condition, medications, compounds, supplements, physician diagnosis, laboratory procedures, immunizations, other information, family history. The main page may comprise navigation points to a patient input display comprising one or more navigation points to other displays or screens with respect to general healthcare facts and for entering specific healthcare facts for the respective general healthcare fact, or to an input display or screen for a doctor or physician to insert specific healthcare facts.

According to the inventive principles, as disclosed in a preferred embodiment, the data base program may comprise a data process for importing or exporting specific healthcare facts between a patient data base and a practitioner data base, know and understood by those skilled in the art as an electronic medical record (“EMR”). The particular system or method for the transfer itself would be dependent on arranging data systems to be compatible and would be known to those skilled in the art, as explained for a preferred embodiment.

The data process for importing or exporting specific health care facts may comprises a data selection process for a selection of respective general healthcare classifications or specific healthcare facts, within a general healthcare classification.

In a preferred embodiment, the data input process may comprise one or a plurality of displays for entering or inserting data. Where data is repeatedly entered, for example, the relevant practitioner and practitioner contact data, for any healthcare facts, the data base data input process may comprises a process for storing for selection, information repeatedly entered and for presenting the repeatedly entered information, for example in a screen drop down menu, for selection and insertion in a respective record.

According to the disclosed inventive principles, as shown in a preferred embodiment, the data base program, may comprise, in at least one of the data base records, notices for respective specific healthcare facts. The notice may be produced in an output display in response to a bar coded healthcare fact, inserted in a data input display. In a preferred embodiment, the notice is produced as an overlay screen. The notice may be presented in a noticeable color like red or yellow and with the notice contained in the overlay window. The notice, with respect to an inserted bar code, may display a warning of adverse use for example, for use of a medication in connection with other medications whether or not prescribed or taken by the patient or in connection with surgeries or allergies or immunizations, shown or recorded in the patient data base record.

The notice, as shown in a preferred embodiment, may be information for a medicine or supplement specific healthcare fact, for example, of an adverse response, outcome, or reaction, to, or for, or from, one or more of said bar coded healthcare facts, inserted in the data base or in response to data inserted in the data base and related general or specific healthcare facts resident in the data base.

In a preferred embodiment, the notice, whether from the same or a separate general classification as the inserted specific healthcare fact, may comprise information of an adverse response, outcome, or reaction, to, or for, or from, one or more of said bar coded healthcare facts. The notice may, present, or advise, or warn, of information of an adverse outcome for a surgical or other procedure, or from a medication or pharmaceuticals, or to an immunization, for example.

According to the disclosed inventive principles and as shown in a preferred embodiment in Patent Publication No. US 2007-0055550 AI, the data base program may comprise a doctor's data input process comprising; a plurality of separate data insertion displays for respective general healthcare classifications and connecting the records of a doctor or practitioner, with the data inserted in the doctor's data insertion display.

In a system and method similar to the patient data insertion process, the doctor's data input process may start with the data process for identifying a bar code for a specific healthcare fact, or a specific healthcare fact for a bar code, in response to a respective healthcare fact or bar code and then insertion of the bar code in the bar code insertion display, or the doctor or practitioner, may insert the bar code directly in the bar code insertion display, for recording the bar coded specific healthcare fact in a respective general healthcare classification.

The doctor or practitioner's records may arrange the specific healthcare facts for a respective general healthcare classification, in a report and said data output display may comprise a bar code for at least one specific healthcare facts.

In addition to inserting a bar code for a specific healthcare fact in a general healthcare fact data insertion display and into the doctor's records, the data input process may comprise reading a bar code from bar coded information, as would be understood by one skilled in the art. In the method or the system for importing or exporting information, as described above, the records for a patient may be imported to or exported from the EMR records of a practitioner and with the same for the reverse process of records exported from the practitioner to the patient or imported from the patient to the practitioner.

In accordance with the disclosed inventive principles, as shown for a preferred embodiment, the bar coded healthcare facts are for respective general healthcare classifications are of general information, or immunizations, or medications or prescriptions, or supplements or compounds, or surgical procedures, or laboratory procedures, other procedures, or doctor's visits or diagnoses, or family medical history, or foreign countries visited, or a personal photo, or DNA analysis, or graphic images from x-ray or other imaging procedures, or physiological analysis, for example of blood or tissue. Other general classifications may be added without departing from the disclosed inventive principles.

As shown in a preferred embodiment, the data output process comprises a process for displaying in the data output display, at least one notice, in response to a bar code for a specific healthcare fact and a respective general healthcare classification, inserted in said data input display for a separate respective general healthcare classification.

As shown for a preferred embodiment in Patent Publication No. US 2007-0055550 AI, the notice comprises information of an adverse response, outcome, or reaction, to, or for, or from, one or more specific healthcare facts, in response to the insertion of a said bar code for a said respective healthcare fact.

As shown for a preferred embodiment, the notices comprise information of an adverse outcome for a surgical or other procedure, or from a medication or pharmaceuticals, or to an immunization.

Shown in this application is an improvement to the Patient Practitioners healthcare data base system as shown and described in the related Patent Publication No. US 2007-0055550 AI.

The inventive principles of the improvements are shown and described in a preferred embodiment, as disclosed herein for the Patient Practitioners healthcare data base program, which comprises a Patient Practitioners data base operating program iPHER and an executable program, used to operate a host CPU in performing the data operations of the Patient Practitioners healthcare data base.

The inventive principles as disclosed for a preferred embodiment, is shown as the Patient Practitioners database and its iPHER.exe executable database program, shown in a preferred embodiment as self contained in a storage drive external to the Host CPU

The Patient Practitioners data base program includes an iPHER executable data processing program which is loaded into the Host CPU, when the external drive containing the Patient Practitioners data base is connected to the Host CPU through a USB port, as shown in a preferred embodiment and as would be understood by those skilled in the art. The Host CPU is operated by the iPHER.exe program to process the healthcare data in the Patient Practitioners data base program, by displaying the Patient Practitioners data base health care records in the respective display screens and by importing and exporting the healthcare data through a virtual portal to a remote Internet location or a local Intranet location.

In a preferred embodiment, the Patient Practitioners database and its iPHER executable program is self contained in a storage drive external to the Host CPU and which may be personally carried for use with any host computer, as needed for examinations, updating or in emergencies.

In a preferred embodiment, the Patient Practitioners healthcare data base in a flash drive, and which may be easily connected to the Host CPU through a USB port, as would be well known and understood by those skilled in the art. As would be understood by those skilled in the art, the iPHER executable program, used operably with the Patient Practitioners healthcare data base is loaded into the Host CPU upon connecting the flash drive to the Host CPU USB port. As would be understood by those skilled in the art, the invention and inventive principles are not limited to use or practice of the invention with a flash drive, or a USB port connection, but may be practiced with any suitable storage medium or device, or connection, now or later developed.

As shown for a preferred embodiment, the Host CPU is operated by the iPHER executable program to process the Patient Practitioners data. At least on operation is to open and operate a virtual portal in the host data for the transfer of data over a data connection to an Internet location or an Intranet location. In a preferred embodiment, the virtual portal is opened when the Patient Practitioners data base is connected to the host computer and the iPHER executable program is loaded into the Host CPU. As known and understood by those skilled in the art, the virtual portal may be opened selectively by a command to the data base system or by connecting the data base using any other now known or developed storage.

The virtual portal operates by providing a data path from the host computer to a selected Internet address or Intranet address. When using a health care data base, there is a need to send the data base records to a storage back up or to health care professionals called upon to review the health care data for medical treatment. As shown for a preferred embodiment, the target location may be the Patient Practitioners central storage location at a remote Internet pre-addressed location or to a doctor's electronic medical record (Doctor's EMR), located in a healthcare facility, for example, a clinic, or a hospital, or a physician's office. The result is any data placed into the data base may be made directly and, concurrently available to the Doctor's EMR or from a Doctor's EMR for updating the Patient Practitioners healthcare data base.

To ensure privacy and security, the virtual portal is closed concurrently with closing of the Patient Practitioners healthcare data base, by the iPHER executable program, for example, by removing the flash drive from the Host CPU USB port.

As disclosed in a preferred embodiment, and by example, the virtual portal comprises an assigned folder C:/PatentPractitioners/xxxx, as may be located, for example, on the Host CPU main drive, and which is used to place data for export to an Internet or Intranet, related Doctor's EMR. As would be understood by those skilled in the art, the folder location would be suitably encrypted or otherwise made secure to prevent unauthorized access to the healthcare information. Similarly, the Doctor's EMR may transmit data through the virtual port to the same folder C:/PatientPractitioners/xxxxxx, for retrieval by the Patient Practitioners program and display or storage. Similarly, the Doctor's EMR healthcare data may be retrieved by the Host CPU through the virtual portal and for display or storage in the Patient Practitioners health care data base.

The inventive principles as disclosed for the Patient Practitioners data base program, as shown in this preferred embodiment as an improvement to the Patient Practitioners healthcare data base system as shown and described in the related Patent Publication No. US 2007-0055550 AI, include in a preferred embodiment according to the disclosed inventive principles, an image storage file identified as “images,” which in a preferred embodiment an image storage identified as Image File, which in a preferred embodiment, is placed in the same portable flash drive as the Patient Practitioners healthcare data base, but separate from the Patient Practitioners data base structure used to hold the specific health care fact records for the respective general health care classifications.

In a preferred embodiment, inside the images file folder within the Images file 41, is another file folder named “sub” containing images, with the storage location identified by a virtual path, for example, in a preferred embodiment, C:/images/sub/xxx.jpg, where “xxx,” in the disclosed path is the file name identifier, as would be understood by those skilled in the art. The advantage of using a separate Images File is the storage of digital files is not restricted by the data base structure with the result the amount of image data that can be stored and the resolution of the images, in increased and enhanced. As would be understood by those skilled in the art, the file structure shown in a preferred embodiment does not limit disclosed inventive principles.

A sub file, within the Images File, as shown in a preferred embodiment, and according to the inventive principles, is connected by the Patient Practitioners database program connecting the stored images with general healthcare classifications and respective specific health care facts records. The separate storage of images data, separate from the Patient Practitioners healthcare data base structure, provides a data store allowing for a number of high resolution images, limited only by the size of the data store and not by the Patient Practitioners data base structure.

In a preferred embodiment of the disclosed invention, the Patient Practitioners data base may import or export healthcare data, through the virtual port. For example, the healthcare data, is sent in a data table, with preset fields and preset types. As would be understood by those skilled in the art, the selected healthcare data from the Patient Practitioners data base is placed in the virtual port folder, for example, C:\\patientpractitioners\xxxx. The data table may remain on the virtual port folder, until it is retrieved by a remote EMR and loaded in the EMR healthcare data base for the respective patient.

The patient's Patient Practitioners data base system and the doctor's EMR, may be used, as would be understood by those skilled in the art, to send or retrieve healthcare data, by selecting an import or export, command button on the respective Patient Practitioners database screen display or remote EMR location to send the data to the virtual portal and in the virtual portal folder, to the remote EMR. For example, and as would be understood by those skilled in the art, by selecting the import command button, a data command is sent from the remote EMR to the iPHER Host CPU that takes the information from the virtual folder C:/PatientPractitioners/xxxx, for example, and places it into the remote Doctor's EMR. The doctor's EMR, transfers the preformatted data tabled and places that information into the appropriate tables within its system.

As would be known to those skilled in the art, the Doctor's EMR program would include a subprogram to import the Patient Practitioners healthcare data in the preformatted table, and place it in respective locations in the Doctor's EMR data base.

According to the disclosed principles of the invention, the import command on the Doctor's EMR is a function of the Doctor's EMR system not a function of Patient Practitioners healthcare data base. This process allows a plurality of EMR's to access the information from an iPHER without requiring the coding, or arrangement of the data in the Doctor's EMR, to be the same as the arrangement of data in the Patient Practitioners proprietary healthcare data base.

The inventive principles as disclosed for the Patient Practitioners data base program include a system and method for changing the language used in the screen displays by importing a language into the system. This advantage permits a change of language by the patient user to accommodate the language in the local area in which the patient may happen to be when health care is indicated or needed.

An improvement to the invention as shown and disclosed in related Patent Publication No. US 2007-0055550 AI, is the Patient Practitioners data base program general health care classifications for entering and storing respective specific healthcare facts for Dental Records and Doctor's Notes.

The invention, as may be practiced in a preferred embodiment, may use a commercially available windows style data base, for example, the Microsoft Access® data base operated by a commercially available IBM™ compatible computer with a suitable operating system, as would be understood by those skilled in the art. The data base data processes for recording, ordering, displaying, printing, or exporting or importing information, may be practiced with any suitable data processing system or method, as known or hereafter developed, which is not part of the disclosed inventive principles, that this invention a data processor is installed in or with.

As known and understood by those skilled in the art, the windows operating system provides screen displays with data entry and display windows for displaying data the Patient Practitioners data base and for transferring data from data entry and display windows, to, or from, the Patient Practitioners data base. An example as would be well known to those skilled in the art, is the masked screen displays used in connection with the Microsoft® Access data base system.

### DESCRIPTION OF THE DRAWINGS

FIG. 1 shows in schematic form, a commercial computer with a flash drive connection to a Host CPU through a USB port and the Patient Practitioners healthcare data base component data resident on the flash drive.

FIG. 2 shows in schematic form, the component Patient Practitioners Data Base system and information flows, according to a preferred embodiment, and as interactive in the Host CPU shown in FIG. 1.

FIG. 3 shows the Patient Practitioners Main Screen, displaying patient contact data and primary patient history data and navigation points to other data output displays and to data input displays and the Patient Practitioners Tool Bar, with its command menu displayed.

FIG. 4 shows the Patient Practitioners Patient Information Input Screen.

FIG. 5 shows the Patient Personal Information Input Form, accessed from the Patient Practitioners Patient Information Input Screen, FIG. 4.

FIG. 6 shows the Personal Information Form Continued, screen, associated with FIG. 5.

FIG. 7 shows the Patient Practitioners Put X-Ray Procedures In Your Medical Records, screen, accessed from the Patient Practitioners Patient Information Input Screen, FIG. 4.

FIG. 8 shows the X-Ray Recording Second Screen, associated with FIG. 7.

FIG. 9 shows the Patient Practitioners Insert EKG Records and Graphs, accessed from the Patient Practitioners Patient Information Input Screen, FIG. 4.

FIG. 10 shows the Patient Practitioners Input EKG Graph For This Record second screen associated with FIG. 9.

FIG. 11 shows the Patient Practitioners Put Dental Insert Dental Records screen.

FIG. 12 shows the Dental Recording Second Screen.

FIG. 13 shows the Patient Practitioners Place Picture In Personal Records screen display, accessed from the Patient Practitioners Patient Information Input Screen, FIG. 4.

FIG. 14 shows the first Digital Images screen.

FIG. 15 shows the second Digital Images screen, accessed from the first Digital Images screen.

FIG. 16 shows the second Digital Images screen of FIG. 15, with the drop down menu commands displayed for adding images to the Images File.

FIG. 17 shows the second Digital Images screen of FIG. 15, with the Images file directory window display of files loaded in the Images File.

FIG. 18 shows the second Digital Images screen of FIG. 15, with a window directory listing folders and drives for batch loading of images in files selected.

FIG. 19 shows the Scan/Acquire command in the second Digital Images screen as shown in FIG. 16 and displayed by selection of the Scan/Acquire command, as shown in FIG. 16.

FIG. 20 shows the Patient Practitioners Back up Not Finished screen as used in the Backup function.

FIG. 21 shows the Patient Practitioners Export Your Medical Information to Doctor's EMR screen display.

FIG. 22 shows the Import New language command in the drop down menu, as shown for the Patient Information Screen of FIG. 4.

FIG. 23 shows the Import New Language Screen.

### DESCRIPTION OF THE INVENTION

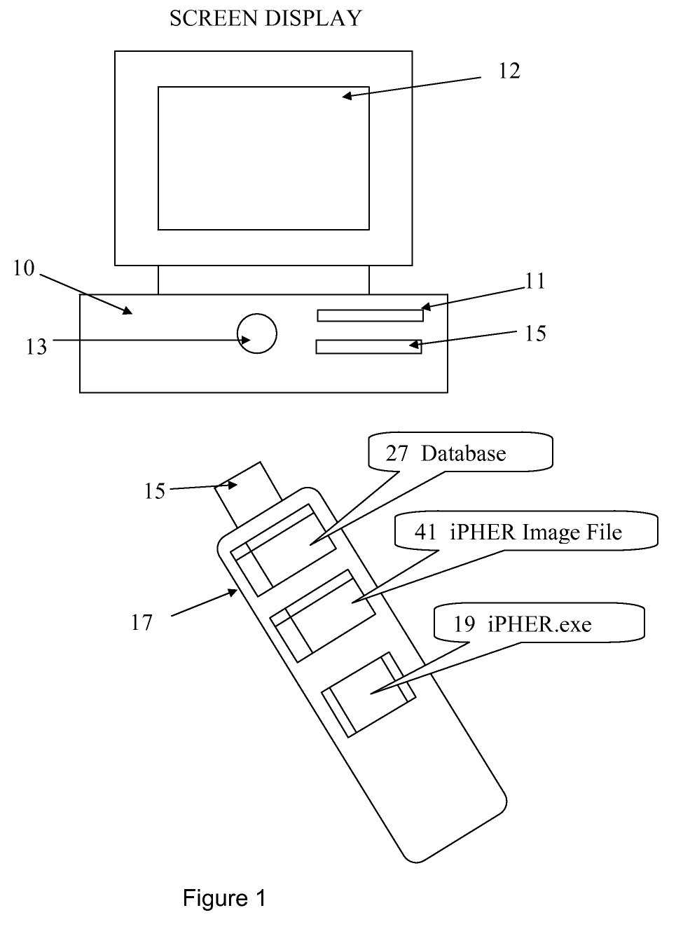

FIG. 1, shows in schematic block form, a general purpose data processor 10, including as representative, a DVD drive 11, on/off switch 13, and USB port 15. As would be known to those skilled in the art, a flash drive 17, containing the Patient Practitioners data base health care program, shown for example by the Patient Practitioners data base 27, comprising the data base health care records and the executable program 19, may be inserted into the USB port, The Patient Practitioners data base program 27, is operatively connected to the host general purpose computer 10, by loading the iPHER executable data processing program 19, into the host computer 10, by the Host CPU 10 operating system, as would be understood by those skilled in the art.

As would be understood by those skilled in the art, for security and confidentiality of the health care fact in the Patient Practitioners data base, the iPHER is kept separately from the host storage except as would be required for generally understood data base data processing. In a preferred embodiment according to the disclosed inventive principles, all data resident in the Host 10, is removed by the iPHER executable program 19, in response to removal of the IPHER flash drive 17 from the host USB port 15.

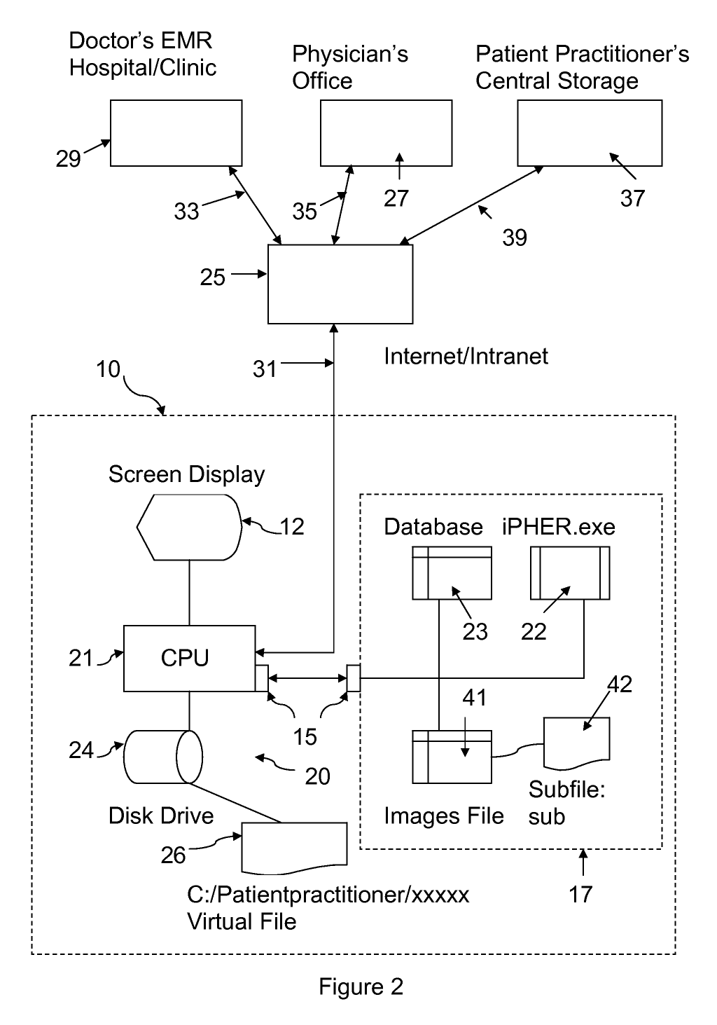

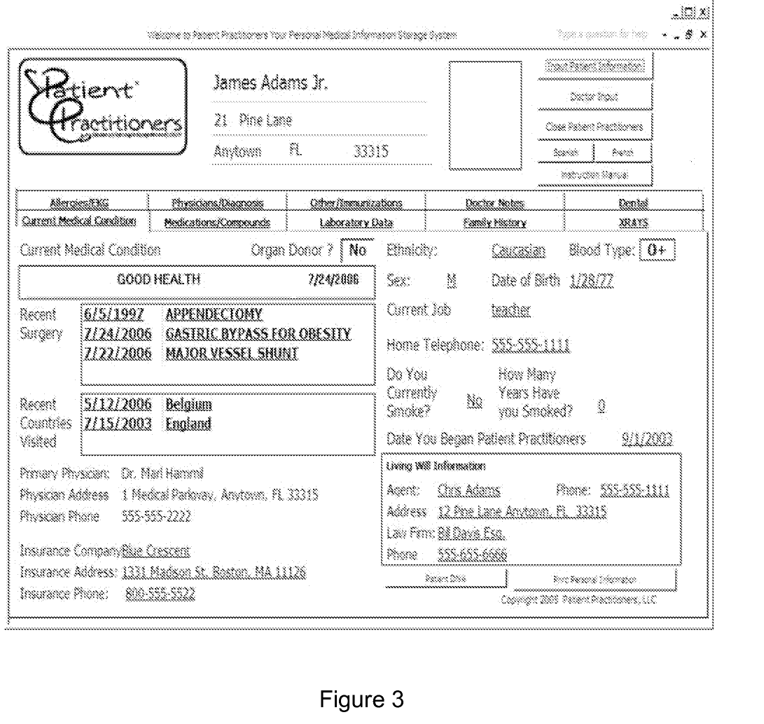

Referring to FIG. 2, in a preferred embodiment, the Host CPU 21 windows screen display operating system, as would be known and understood by those skilled in the art, responds to the connection of the iPHER flash drive 17 to the Host CPU 21 through the USB port 15, and loads the iPHER executable program 22, into the Host CPU 21 and opens on the screen display 12, the Patient Practitioners Main Page screen display, as shown in FIG. 3, and opens the virtual portal 20, as explained below.

In a preferred embodiment, invention's Patient Practitioners healthcare data base system comprises the iPHER executable program 22. The iPHER executable 22, is loaded on he Host CPU 21 and operates the Host CPU 21 to open and operate the virtual portal 20, as shown in FIG. 2. In a preferred embodiment, the virtual portal 20 is opened when the Patient Practitioners data base is connected to the host computer 10 which occurs when the flash drive 17 is inserted in the host computer's USB port 15, as shown in FIG. 1, and matching USB connection 15 on the flash drive 17, as shown in FIG. 2, in a preferred embodiment. As would be known to those skilled in the art, the virtual portal 20 may be opened selectively by a command from the Patient Practitioners data base system or by connecting the iPHER drive 17 to the host 10 and host CPU 21, or by any other interactive relationship of the Patient Practitioners data base, stored in any other now known or developed storage medium or facility.

The virtual portal shown generally by numeral 20, and comprising the CPU 21, the virtual file 26 and the Internet/Intranet connection 31, as shown in FIG. 2, operates by providing a data path from the host computer CPU 21, shown enclosed by dashed lines 10 schematically enclosing the iPHER flash drive 17, through a connection 31 to the Internet or Internet 25, and through connections 33,35,39, for example, from the Internet, Intranet, 25, to a selected Internet address or Intranet addresses to a Doctor's EMR or EMR in a healthcare facility or a physician's office, as shown by numerals 29, 27, respectively, or to the Patient Practitioners Storage 37.

As would be understood by those skilled in the art, in the use of a of a health care data base, there is a continuing need to send the Patient Practitioners data base records to a storage back up 37, or to health care professionals called upon to review the health care data for medical treatment, at a health care facility, for example as shown by numeral 29 or 27. The virtual port 20 may serve as a direct path to a Doctor's EMR for example in a hospital or clinic. as shown by numeral 29, or, or to a physician's office, for example as shown by numeral 27, or to a back up storage, example as shown by numeral 37, through connection 39.

As would be understood by those skilled in the art, the Internet/Intranet 25 and connections 31, 33, 35, and 37, are shown for explanation and the inventions as shown In a preferred embodiment, would not be limited to the connections or the data flow paths as used herein.

As would be known to those skilled in the art, the iPHER executable 22, shown loaded into the CPU 21 active memory in the host data processor 10, may operate the host CPU 21, to respond to any new information, for example by providing a notice or alarm, where the patient requires emergency treatment or data is sent for prompt medical review and analysis.

The virtual portal, shown generally by numeral 20, and comprising the CPU 21, the disk drive 24 and virtual file C:/PatientPractitioners/xxxx 26, and the Internet/Intranet connection 25, as shown in FIG. 2, in a preferred embodiment, may be arranged to ensure privacy and security, by closing the virtual portal concurrently with closing of the Patient Practitioners health care data base. This may be arranged to occur on removal of the data base connection to the host CPU 21. The executable program 22 may be arranged to ensure privacy and security by obliterating or removing, as would be known to those skilled in the art, when the iPHER drive 17 is removed from its connection to the host 10 and the host CPU 21.

As would be know to those skilled in the art, the iPHER executable program 22, shown loaded into the CPU 21 active memory in the host data processor 10, may operate the host data processor 10 to open the virtual portal 20 and to connect the host 10 and the Patient Practitioners data base to selected Internet/Intranet addressed locations, for example, the health care facility 29, or physicians office 27, or to a storage, for example, as shown by 37. Similarly the host 10 may be programmed by the iPHER executable 22 to respond to any new information received through virtual portal 20, for example by providing a notice or alarm, where the patient requires emergency treatment or the data is sent for prompt medical review and analysis.

According to the disclosed inventive principles, the host CPU 21 is programmed by the iPHER executable program 22, to erase or obliterate all of the Patient Practitioners data base information, in the host 10 data storage, when the iPHER flash drive is 17, is removed. The program operations causing destruction or removal or rendering any Patient Practitioners data base health care information unreadable, in the host10, would be known to those skilled in the art.

The invention and inventive principles, are shown and described as an improvement to the invention shown and described in Patent Publication No. US 2007-0055550 AI. As shown in FIG. 3. the initial screen is presented as a Main Screen, identified as a general healthcare classification screen as explained in the following, for its display of general or basic patient healthcare facts, for example, the patients general condition. Separate from the Main Screen, the Patient Practitioner Icon is displayed on the tool bar displayed on the screen display 12, by the CPU 21 operating system as would be known to those skilled in the art to produce a command menu on its selection using the Windows™ point and click system for selection of Windows™ displayed commands. The Patient Practitioners Icon may be used, as shown for a preferred embodiment, for record Access, Registration, Backup, to Remove the iPHER drive, shown for a preferred embodiment as the flash drive 17. In a preferred embodiment, the Main Screen will be displayed on the screen display 12, by using the Patient Practitioners Icon on the screen displayed tool bar as shown in FIG. 3, and the Access command.

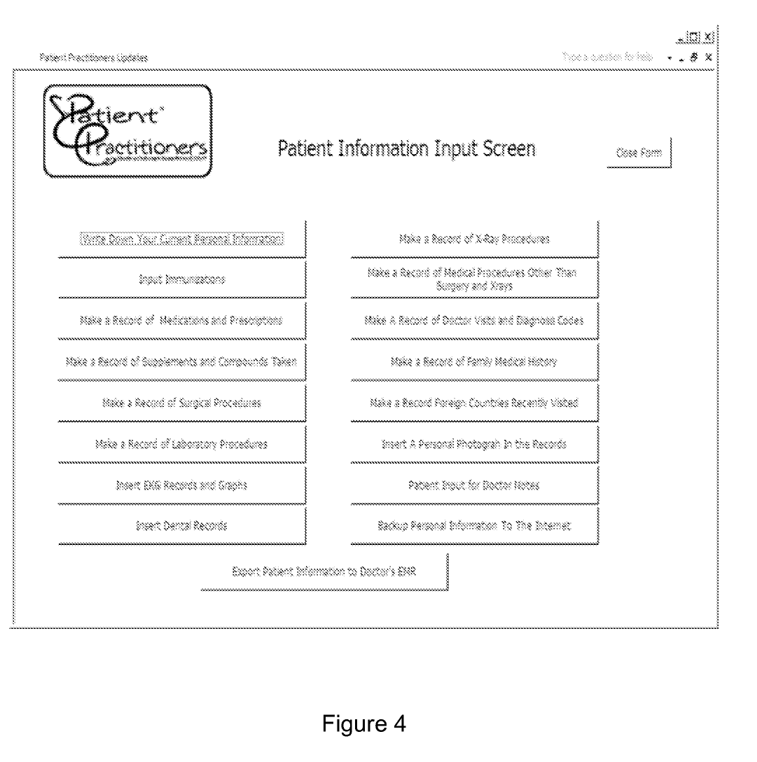

For a preferred embodiment, the Main Screen, FIG. 3, may serve as a data display of the patient's general condition and provide navigation points to the other Patient Practitioners display screens, as shown by the identified navigation selection points, for example by the selection buttons Doctors Notes, and Laboratory Data, or to the Input Patient Information screen as shown in FIG. 4, providing selection buttons for accessing and inserting specific healthcare facts in respective General Healthcare classifications.

For example and as shown for a preferred embodiment, in FIG. 4, the Patient Input Information Input Screen, FIG. 4, may be used through its identified selection buttons to access the General Healthcare input information screens, for example, immunizations, surgical procedures and medications. As shown and described in Patent Publication No. US 2007-0055550 AI, the specific healthcare facts for respective General Healthcare classifications, as shown by the identified selection buttons on the Patient Input Information Screen, may be entered or displayed, for storage locally or at a remote location, as described herein.

For a preferred embodiment, input screens displayed by the CPU 21 operating system as would be known and understood by those skilled in the are, are the means for the insertion of specific health care facts into the data base and display of the inserted specific healthcare facts in the respective general healthcare classification screens. In a preferred embodiment, the patient's specific healthcare facts are displayed or entered in relation to the respective general healthcare classifications, for example as shown in the Patient Information Input Screen as shown in FIG. 4.

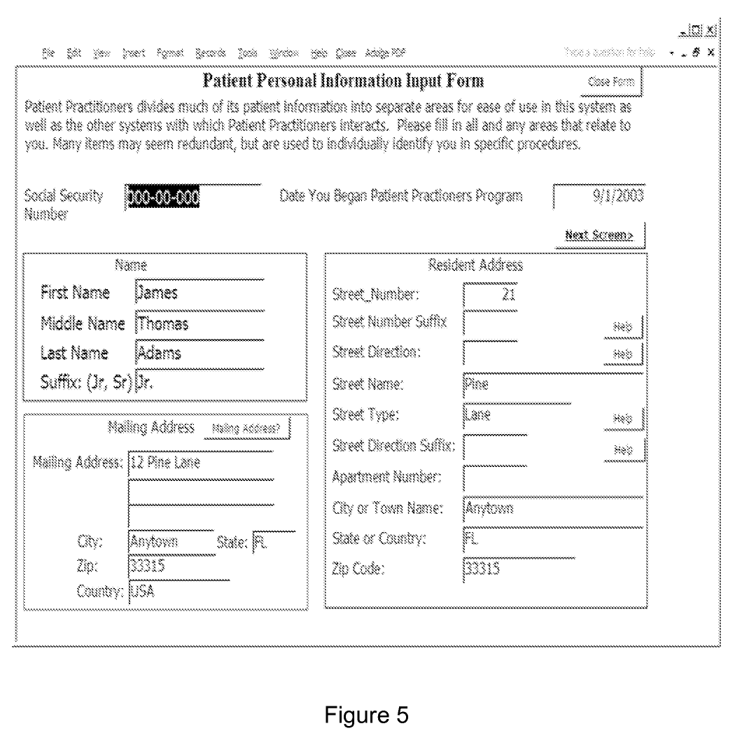

In a preferred embodiment, the general healthcare classifications may comprise general classification healthcare basic facts. For example, proceeding from the Patient Information Input Screen, FIG. 4, to the Patient Practitioners General Classifications for healthcare information, as shown by the identified selection buttons navigation points, as shown in FIG. 4, to the General classification data insertion displays for example by selecting the selection button Write Down Your Current Personal Information, the CPU 21 displays the Patient Personal Input Form, as shown in FIG. 5, for insertion and display of the specific healthcare facts related to personal information, the patient ID, contact data for the patient and the patient's healthcare providers and insurers, allergies, as shown for a preferred embodiment.

As shown by the other navigation points for the general healthcare classifications in FIG. 4, data insertion displays may be displayed on screen display 12, for general healthcare classifications of recent surgeries, recent visits outside the patient's native country, a statement of the patient's present condition, immunizations, medications and prescriptions, supplements and compounds taken by the patient, surgical procedures, laboratory procedures, x-ray procedures, and other procedures, doctor visits and diagnosis, family medical history, foreign country visits, and other general classifications as may be modified or added, as would be understood by those skilled in the art.

The Main Screen, as shown in Patent Publication No. US 2007-0055550 AI, and as used in a preferred embodiment herein as shown in FIG. 3, as a General Healthcare Classification screen, may comprise windows for general or basic patient information, comprising name, address, organ donor, ethnicity, blood type, date of birth, sex, current medical condition, recent surgery, recent countries visited, smoker or not, primary care physician and insurance company, organ donor, and related facts. Without departing from the disclosed inventive principles, the Main Screen, Page, FIG. 3, may comprise other information, as may be considered useful or required in providing an immediate picture of vital health care information, as might be needed for example for critical trauma treatment.

The Main Screen, as shown in Patent Publication No. US 2007-0055550 AI, and in FIG. 3, herein, in a preferred embodiment, may include various navigation points or buttons for navigating to others of the general healthcare classification screens, for the display of the information in the data base record, for example, X-Rays, Allergies, Medications/Compounds, Physicians/Diagnosis, Laboratory Data, Other/Immunizations, and Family History and for navigating to the Input Patient Information screen, as shown in FIG. 4, as explained above, and repeated for the purpose of explanation.

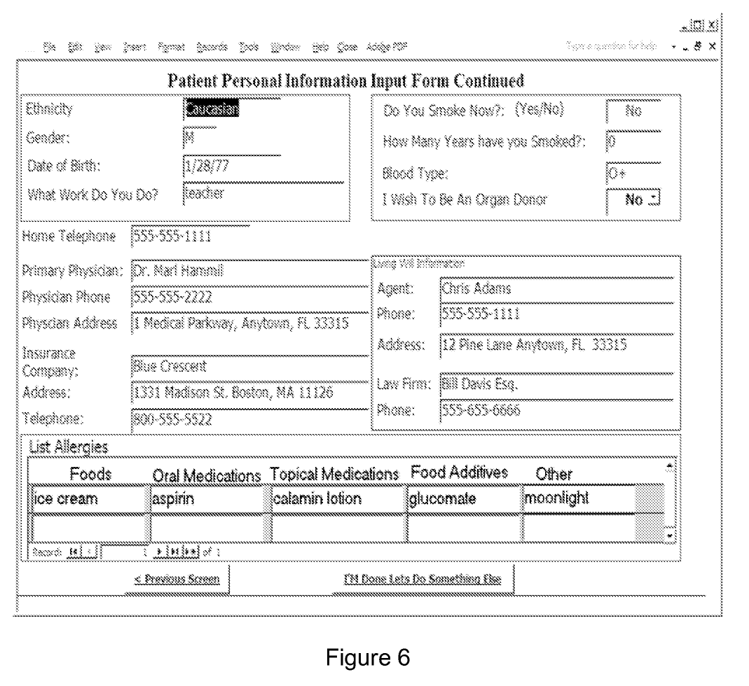

The Patient Information Input Screen, as shown in FIG. 4, and displayed by selecting the Insert Patient Information button in the Main Screen FIG. 3, in preferred embodiment, is accessed by the patient to access the data insertion displays, as shown, for example to access for display and data insertion, for the Patient Personal Information Input Form, FIG. 5, and Patient Personal Current Personal Information Form Continued, as shown in FIG. 6.

The navigation points or points, or buttons displayed for use in a preferred embodiment, on Patient Information Input Screen, are for access of the general classification input screens and the patient insertion of specific healthcare facts within the general healthcare classifications in a preferred embodiment, of Current Personal Information, Immunizations, Medications and Prescriptions, Supplements and Compounds Taken, Surgical Procedures, Laboratory Procedures, X-Ray Procedures, Doctor Visits and Diagnosis, Family Medical History, Foreign Country Visits, or for the insertion of a Photo.

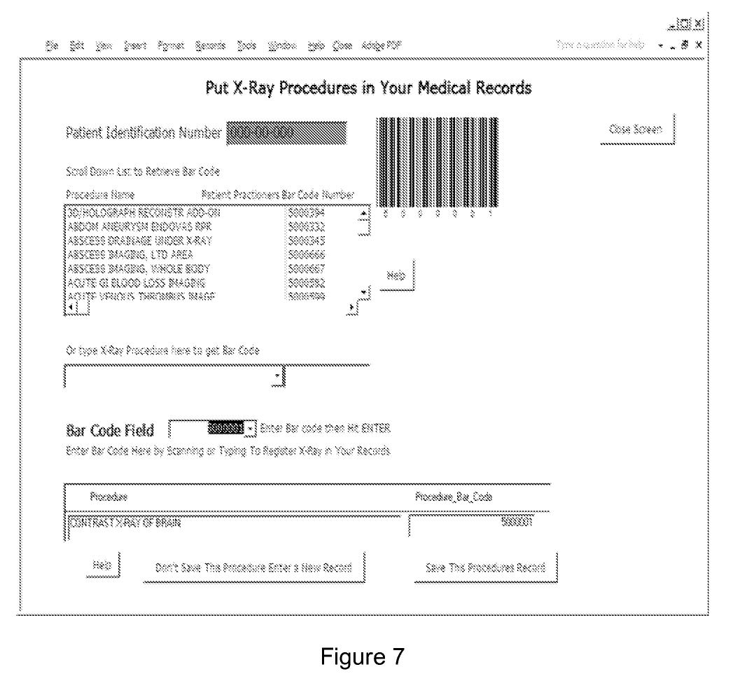

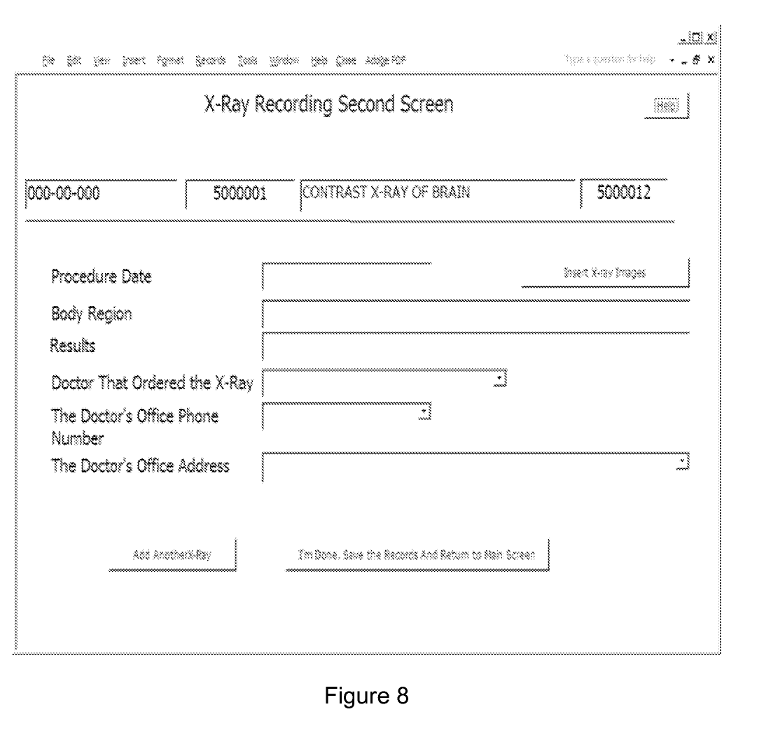

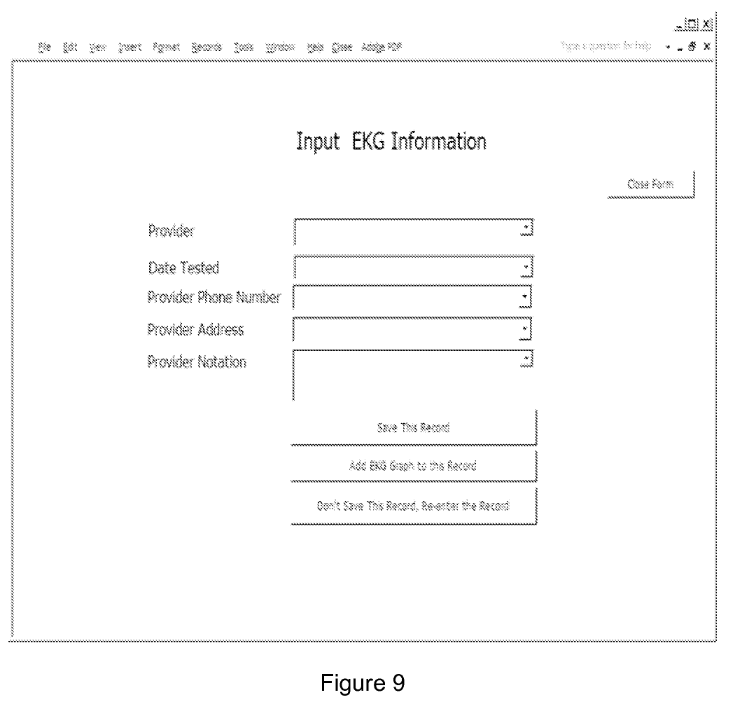

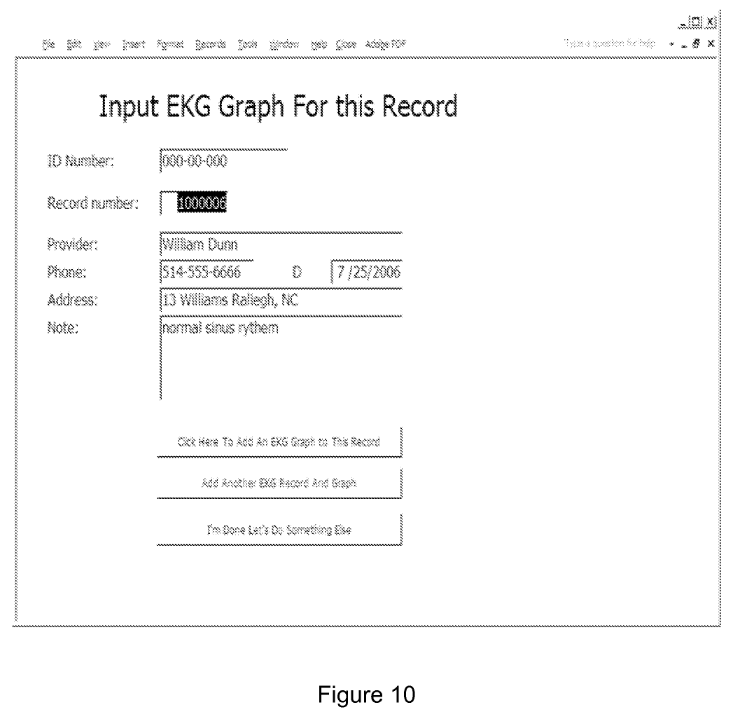

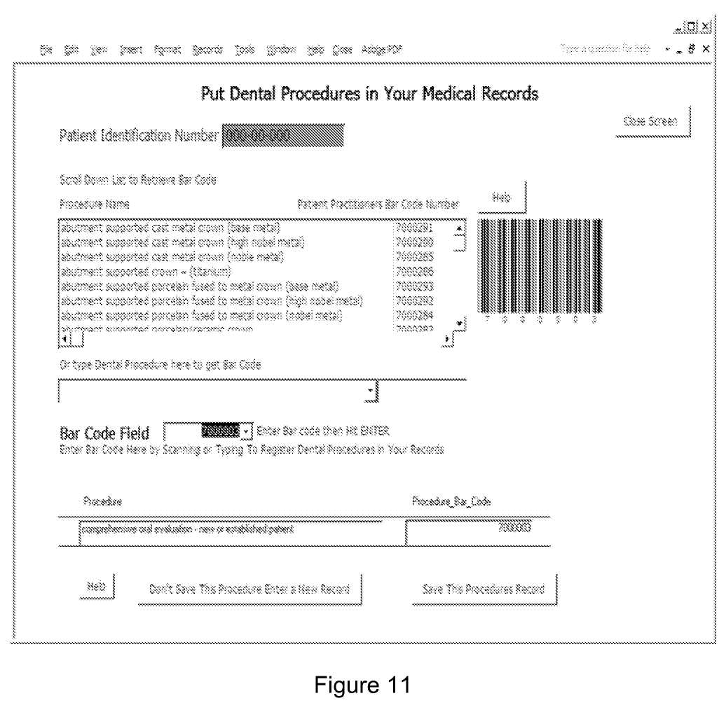

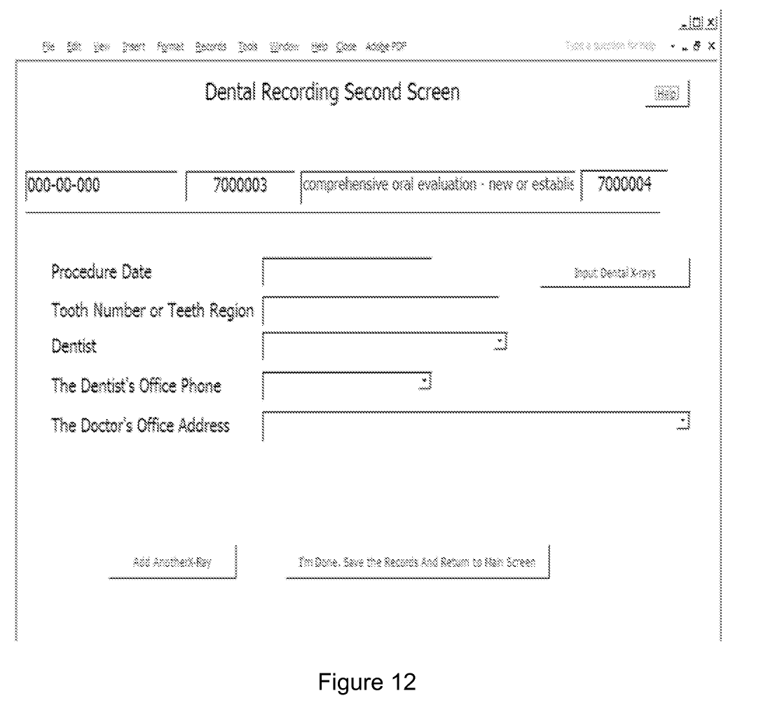

As shown and described in Patent Publication No. US 2007-0055550 AI, and as shown in FIG. 4, herein the Make A Record of X-Ray Procedures selection button may be selected to display the general classification screen Put X-Ray Procedures In Your Medical Records screens FIGS. 7 and 8, on Host 10, screen display 12. Similarly, the selection of Insert EKG Records and Graphs, FIGS. 9 and 10, and the Put Dental Procedures in Your Medical Records, FIGS. 11, 12, will display the corresponding Patient Practitioners screen displays, on Host CPU 21, screen display 12.

As shown and described for FIG. 8, insertion of x-ray images for a preferred embodiment, is through the X-Ray Recording Second Screen. Similarly, EKG Records and Graphs are placed in the Patient Practitioners healthcare data base through the Input EKG Graph For This Record screen, FIG. 10 and Dental x-rays and images are placed in the Patient Practitioners healthcare data base through the Dental Recording Second Screen, FIG. 12.

As disclosed in a preferred embodiment, and an improvement to the process and system for storing and for placing x-rays, graphical data, and other images, in or with the Patient Practitioners healthcare data base as shown in Patent Publication No. US 2007-0055550 AI.

According to the principals of the disclosed invention, as shown in a preferred embodiment, the images for the health care data base 23, are stored in an image file 41, separately from the Patient Practitioners relevant healthcare specific data base structure and records. The advantage of separately storing the images from the Patient Practitioners healthcare data base structure, in a separate image file 41, as shown in FIG. 2, is a facility for storage of image files which is not limited by the size of the data base structure and is limited only by the size of the storage medium or drive. Another advantage is transfer of images directly from the Image File 41, to the a remote storage for example the Internet connected storage 37, without transfer of any data stored in the Patient Practitioners data base and the use of the images transmitted to a doctor's office, clinic, or hospital, for example, in high resolution 3-D imaging equipment.

By separate storage of the images in an image file 41, separate and apart from the Patient Practitioners data base structure 23, images may be acquired and placed in the storage medium 17, for example, directly from scanners, cameras, or by the traditional method of cut and paste, without accessing or opening the data base 23.

The acquisition of digital images may be by any conventional and know system, as would be understood by those skilled in the art be understood by those skilled in the art. In a preferred embodiment, for example, the digital image may be loaded in the drive 24 of host 10, by file transfer from or through the Internet, or from a digital camera, or from a scanner, as would be well known to those skilled in the art.

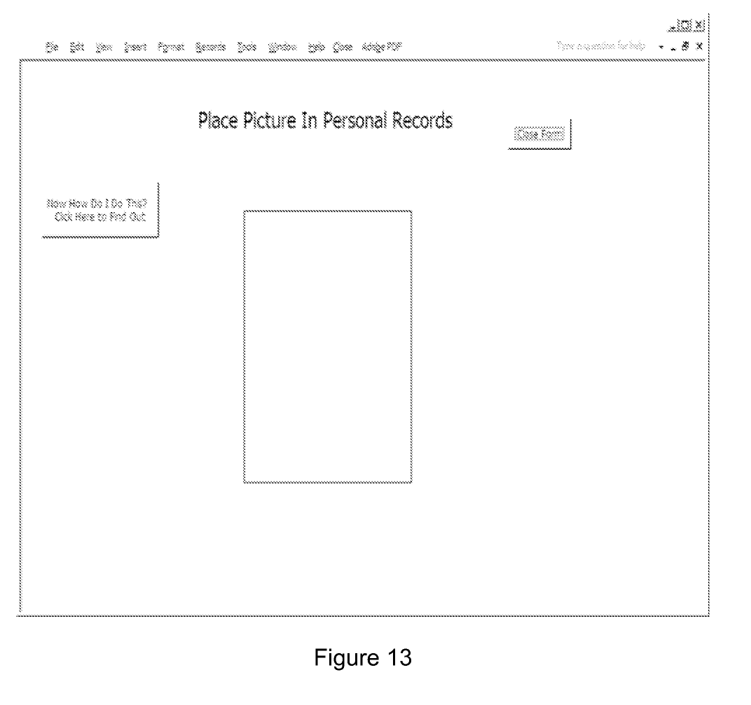

For example, to load a personal picture into the Place Picture In Personal Records screen, the Place Picture in Personal Records screen display FIG. 13, is accessed by selecting the Insert a Personal Photograph in the Records button in the Input Patient Information screen display FIG. 4.

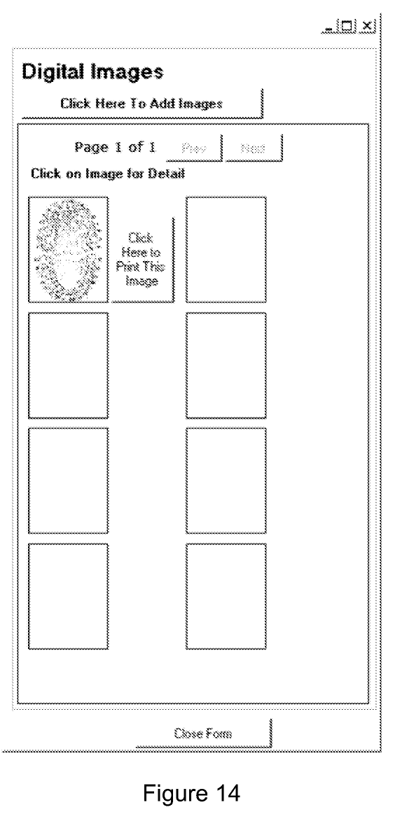

As shown for the inventive principles, disclosed in a preferred embodiment, a Digital Images screen is used to place digital images, comprising x-rays, photographs, EKG graphical data and dental x-rays or other digital images in the Patient Practitioners healthcare data base. For the insertion of digital photos, the Digital Images screen, FIG. 14, may be accessed from the Place Pictures In Personal Records screen. In a preferred embodiment, as shown for example using a windows screen display, a drop down menu may be accessed using the screen cursor or pointer and a command, for example a mouse command, as would be understood to those skilled in the art, to access the paste, load, acquire, or other commands for copying, acquiring, or loading, an image or image file into the Images directory, as shown and disclosed herein.

The Digital Images screen display FIG. 14 is used to access a second Digital Images window which includes drop down menus and commands for placing images in the Image File directory. In a preferred embodiment, a image in an file, for example in a file in the C:/ drive in drive 24, may be copied using the standard features available in any conventional photo editor or graphics program, Paint or Microsoft Photo Editor or Acrobat Photo Editor, or acquired from a camera or scanner, using the Twain 32.

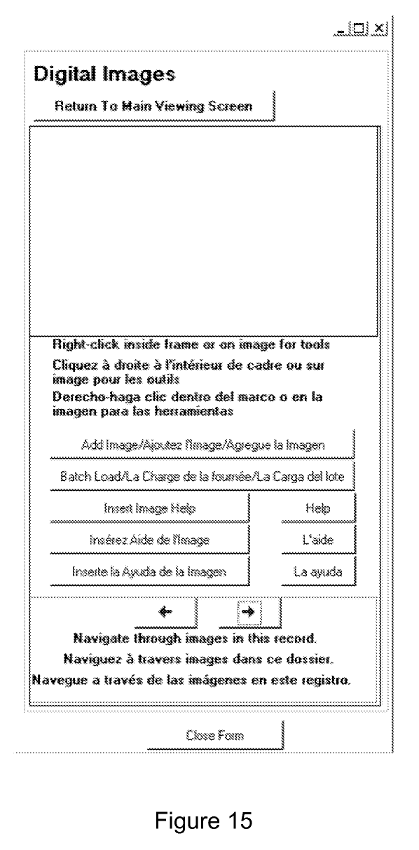

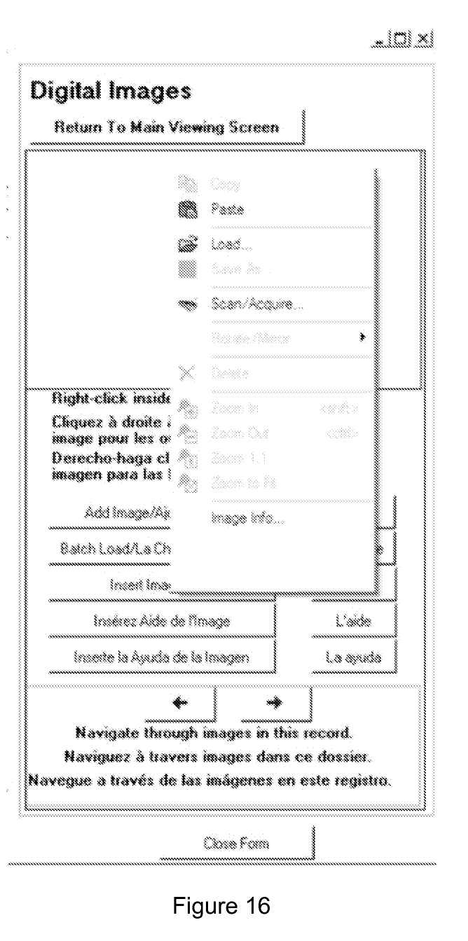

As disclosed in a preferred embodiment, a second Digital Images screen display, FIG. 15, is displayed on screen display 12, by selecting the Click Here to Add Images selection button in the first Digital Images screen, FIG. 14. In a preferred embodiment, as would be known to those skilled in the art of windows display operating systems, drop down command menus are provided, in response to cursor produced signals with respect to the location of the cursor on selected or defined located on the screen displayed on screen display 12. Fore example, placing the cursor over the Input Picture section, shown in FIG. 15, and selecting the desired command from the drop down menu, as shown in FIG. 16, for example, Paste, Load, or Scan/Acquire, by right clicking on the cursor control or mouse, as would be known by those skilled in the art, images may be copied and pasted, loaded individually or in batch or acquired from a scanner or digital camera, for placement in the Images File 41.

The windows programming for screen responsive drop down menus and command issues or made through screen displayed drop down menus, is well known to those skilled in the art and does not form a part of this invention.

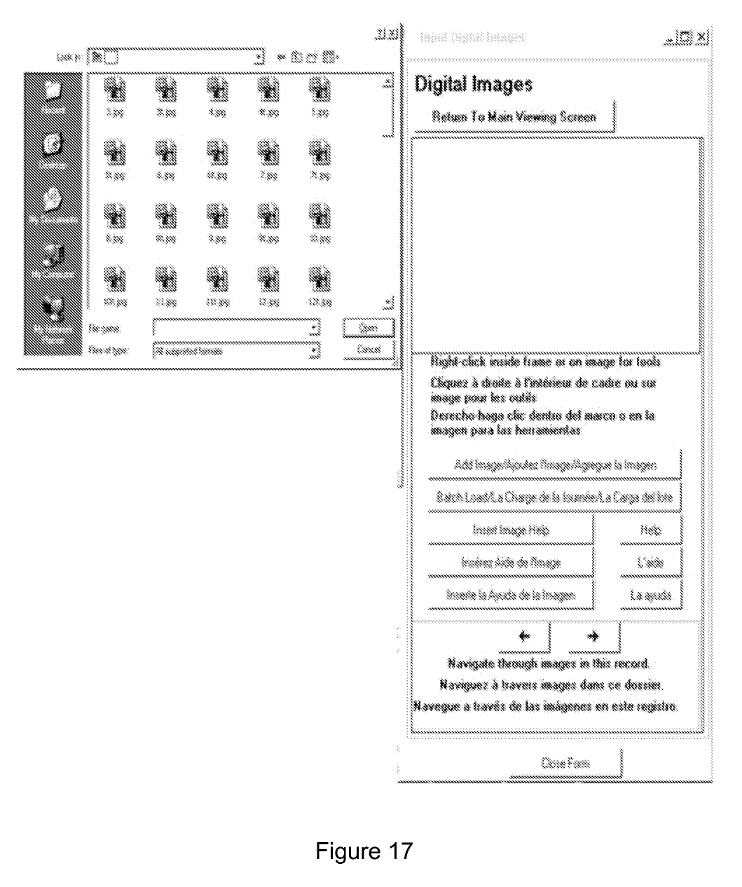

Images copied from another file, for example, another file on the drive 24, can then be pasted into the window frame provided in the Digital Images screen FIG. 15 using for example, the paste command in the drop down menu. By selecting the Return to Main Viewing Screen, selection button the executable program 22, will display the Images Record directory screen and a corresponding file listing for the digital photo entered, as shown in FIG. 17. As would be known to those skilled in the art, additional photos may be added in the same way and with the same result.

Instead of using the paste command, a load command, as shown in FIG. 16, is available in the drop down menu. By selecting the Load command in the drop down menu instead of the paste command, a directory will be displayed, as shown in FIG. 17. the display will the a window Image directory as shown in FIG. 17. In a preferred embodiment, this conventional directory window can be used to navigate to other directories and files, on the CPU drive 24, for example which contain images, which may be imported in the Images directory. As would be understood by those skilled in the art, an image in a directory other than the Image directory may be opened to place the image for viewing in the Digital Image screen frame, as shown in FIG. 15. The image may then be added to the Image directory by selecting the Batch Loaded selection button, as shown in FIG. 17.

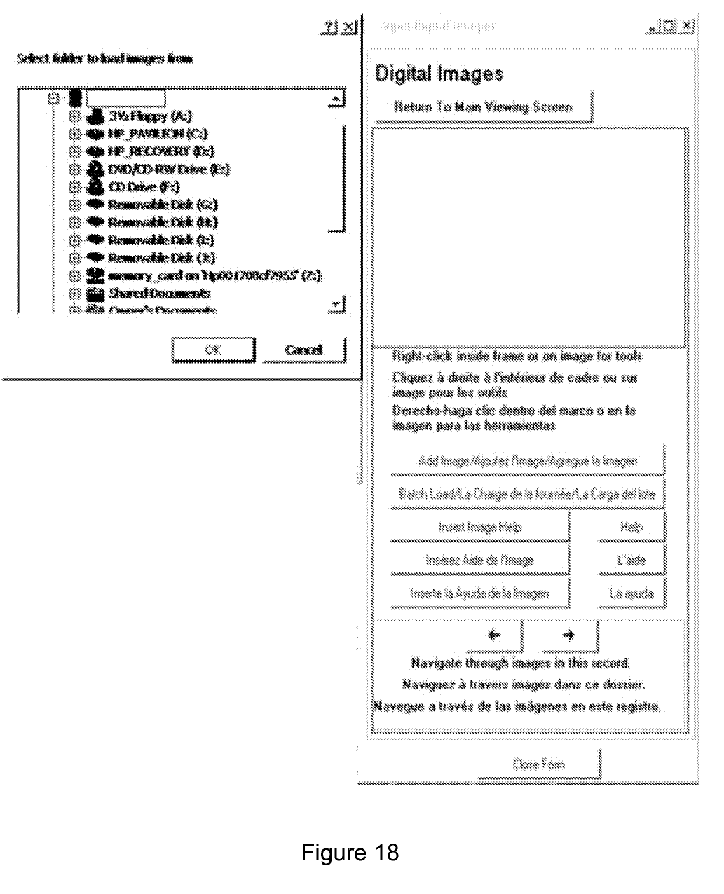

In a preferred embodiment, a Batch command is available, as shown in FIG. 18, to load multiple images at once. The Batch Load button on the Digital Images screen, FIG. 18, will access and display a smaller screen next to the Digital Images screen, listing the various drives and folders on the host computer 21, drive 24, for example. As conventional and as would be understood by those skilled in the art, this smaller screen listing the drives and folders accessible to the host computer 21, may be used to navigate to the folder that contains the batched pictures that are designated for loading into the image records for the Patient Practitioners data base. This folder can be on any drive or network that is attached to this computer.

As conventional and as would be understood by those skilled in the art and as would be conventional in a windows operating system in CPU 21, highlighting a folder and selecting the ‘OK’ button, in the windows directory window, will all the files, selected by highlighting, as would be known to those skilled in the art, into the Images File directory. The loaded images may be viewed by use of the navigation buttons at the bottom of the Digital Images screen, as shown for example in FIG. 15.

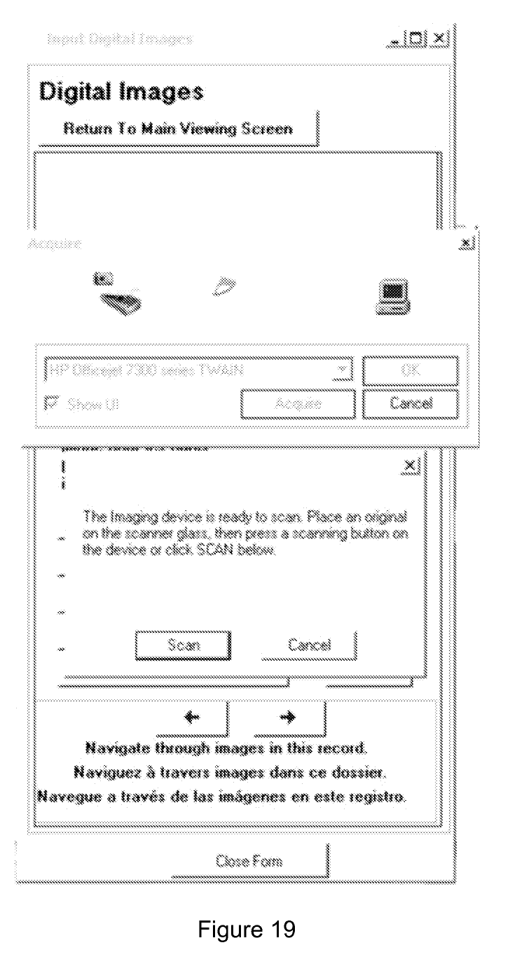

Images may be loaded into the Images directory from a Web Cam or Digital Camera, accessing the Scan/Acquire command in the Digital Images drop down menu, as shown in FIG. 19, and as explained above with reference to a digital photo. Selecting the Scan/Acquire command from the drop down menu. as shown in FIG. 16, will produce or access a small screen will appear labeled Acquire, as shown for a preferred embodiment in FIG. 19, may be used to select a device connected to the host CPU 21 from which the digital image is to be produced. After selecting the device, another screen display, a Scan selection button will be displayed and selecting the Scan button will activate the acquiring device, as disclosed in a preferred embodiment, a scanner and display the image, as would be understood by those skilled in the art, in the frame as shown in FIG. 15.

Scanning is well known to those skilled in the art, for example using TWAIN 32, and any photo editor program using TWAIN 32, could be used and are well known to those skilled in the art. The digital images produced by multiple scanning could be viewed and placed in the Images File and listed in the Images directory.

In a preferred embodiment, where digital x-ray or other graphical images are loaded, the loading process will start from a general classification screen display, for example the Input EKG Graph For This Record screen display. FIG. 10, selecting the Click Here to Add an EKG Graph to the Record will display the Digital Images screen display as shown in FIG. 15. The process for adding digital data images, for example, x-rays, graphs, photos, or scanned images to the Images File directory, would be as described above.

Similarly, the loading of digital images for the general classifications of X-Rays or Dental Records, would b by accessing for display the Dental Recording Second Screen, FIG. 12 or the X. Ray Recording Second Screen, FIG. 8, and selecting the Click Here to Add Images for Dental Records or Input X-Ray Picture, respectively, to display the Digital Images display FIG. 15, and then selecting and adding the images to the Images Files directory, as described above.

### Backup

The back up function and operation of the inventive system, as disclosed herein for a preferred embodiment, is initiated by selecting the Input Patient Information button on the Main Screen, FIG. 3, and accessing the Patient Information Input screen display as shown in FIG. 4.

As shown in a preferred embodiment, for the disclosed inventive principles, there is a backup function and operation, used to preserve the patient's healthcare records stored in the Patient Practitioners healthcare data base, that may be selected by use of the Registration and Backup Personal Information button, located in the Patient Information Input Screen, FIG. 4.

Selecting the Backup Personal Information To The Internet button on the Patient Information Input screen display, FIG. 4, begins the back up process of backing up health care data from the Patient Practitioners data base 23. As would be understood by those skilled in the art, the information in the Patient Practitioners data base 23, is sent to a virtual file in the drive 24 for the CPU 21, a file identified on the CPU 21 C Drive as C://PatentPractitioners/xxxxx, as shown in FIG. 2, and associated with the virtual portal 20, as shown in FIG. 2. As shown for a preferred embodiment, the C drive location provides a local storage location for holding data in the virtual portal for transmission through the Internet, for example Internet connection 25 and connections 31 and 39, to the Patient Practitioners central storage location 37, as shown in FIG. 2, and as would be understood by those skilled in the art.

As would be understood by those skilled in the art, the virtual portal 20 as shown and described herein, is a physical construction of the virtual portal store, shown for a preferred embodiment on the drive 24 and the iPHER executable program 22, loaded in the CPU 21 and used to operate CPU 21 to transfer specific healthcare facts as arranged in the general healthcare classifications to or from the Patient Practitioners Data Base 23, or to connect the CPU 21 to the Internet 25 and export the healthcare data on the virtual portal location in the directory 26 or import healthcare data from the Internet 25 to the virtual portal location in directory 26.

As explained above, with respect to the virtual port on the CPU 21 local drive and is then sent by operation of the 22, executable program from the virtual drive 26, through the virtual portal 20 to a pre addressed secure storage location 37, as explained in the following.

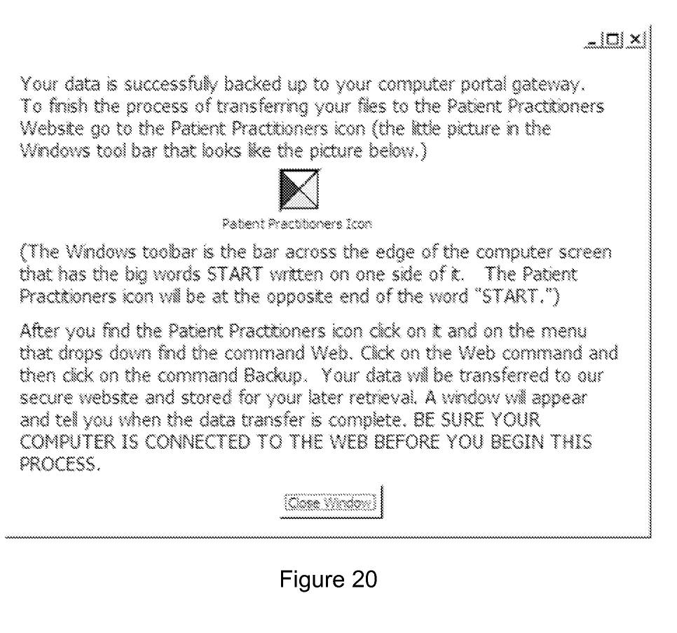

As shown for a preferred embodiment, and according to the disclosed inventive principles, selecting the Backup Personal Data button, on the Input Patient Information screen, FIG. 4, transmits the Patient Practitioners data to the C drive virtual portal location on drive 24, shown herein for a preferred embodiment as C:/PatientPractitioners/xxxx. An instruction screen is displayed Backup Not Finished, FIG. 20. The instructions in this screen display instruct the selection of the iPHER Icon, placed in the CPU 21 windows screen display tool bar on screen 12, and as would be understood by those skilled in the art. The IPHER Icon, as shown in FIG. 20, is placed in the windows screen display tool bar, when the Patient Practitioners Data Base program iPHER executable 22, is loaded in CPU 21, as would be understood by those skilled in the art. The iPHER Icon is shown and described with reference to FIG. 20.

According to the disclosed inventive principles, as shown for a preferred embodiment, selecting the iPHER Icon, displayed on the windows screen display tool bar, displays a menu as would be known to those skilled in the art, with the command Backup. The CPU 21, in response to the selection of the drop down menu Backup command, exports the healthcare data in the virtual portal 20 drive, place in the directory C:/PatientPractitioners/xxxx, as explained above, through the Internet, 25 and associated connections 31 and 35 to the Patient Practitioners Internet storage location 37.

In a similar manner, according to a preferred embodiment and the disclosed inventive principles, the data base health care information may be sent to a selected plurality of Internet or Intranet locations to a Doctor's EMR or health care facility. It will be understood by those skilled in the art, that by doctor's EMR is meant any location other than the storage 37, where the information is needed or desired.

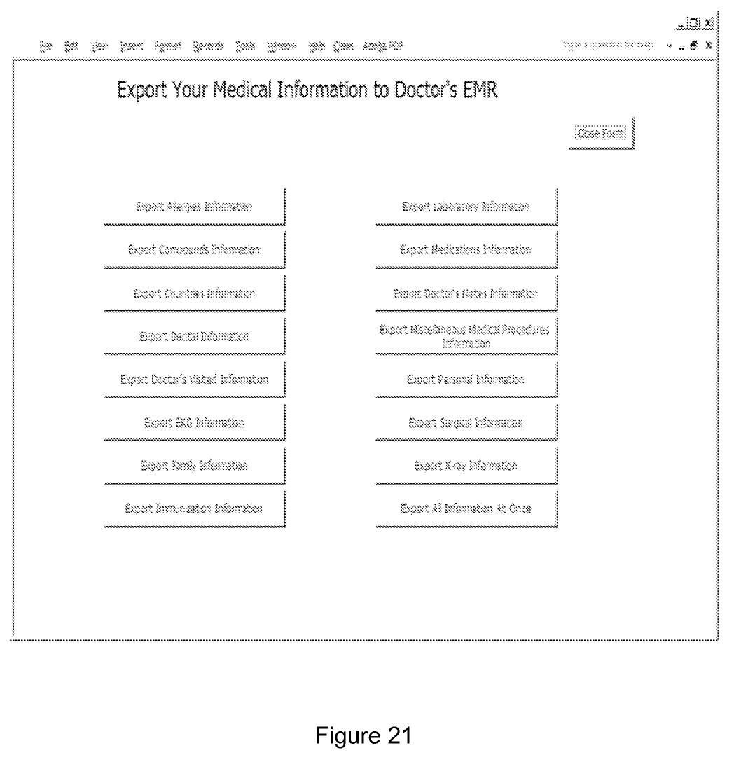

While the process of backing up data to a storage facility 37, and is under the control of the iPHER executable program, the transmission of the health care data to a selected Doctor's EMR, in any selected location, for example, clinic, hospital, or doctor's office, is interactively with the doctor's EMR. The process may be started by selecting the button labeled ‘Export Patient Information to Doctor's EMR’ on the Patient Information Input Screen as shown in FIG. 4. The screen display Export Your Medical Information to Doctor's EMR, will appear, as shown in FIG. 21.

The Export Your Medical Information to Doctor's EMR screen display, as shown in FIG. 21, for a preferred embodiment comprises sixteen separate buttons enabling a choice of separate respective information to transmit to the Doctor's EMR. Similarly, all of the health care information in the Patient Practitioners data base 23 may be loaded into the virtual portal 20, files in the virtual portal directory C:/PatientPractitioners/xxxx, on drive 24, for ready access by the Doctor's EMR. By selecting separate general health care classification buttons, as shown in FIG. 21, or selecting Export All Information button, the selected data from the Patient Practitioners data base is sent to the virtual portal directory on drive 24, and is then ready for access from, and transmission to a Doctor's EMR, as would be understood by those skilled in the art. In a preferred embodiment, the Doctors EMR program may process the data formatted according to the Patient Practitioners Data Base structure and reformat is as may be necessary to suitable for storage in the Doctors EMR, as would be understood by those skilled in the art.

The Doctor's EMR, as would be apparent to those skilled in the art, can be programmed to accept the data base arrangement of the file format fields, field types and sequence of the information imported, from the Patient Practitioners healthcare data base and arrange it in place in the appropriate tables within Doctor's EMR. Similarly, as would be apparent to those skilled in the art, the data in the Doctor's EMR may be arranged in the file format of the Patient Practitioners data base for exporting to the Patient Practitioners healthcare data base. The import command on the Doctor's EMR is a function of the Doctor's EMR system not a function of Patient Practitioners. This process allows multiple EMR's to access the information from an iPHER without Patient Practitioners needing to know the coding, information storage systems or process for any EMR and keeps their and Patient Practitioners proprietary coding secure.

### Language Translations

The specific health care facts in the Patient Practitioners data base 23, in a preferred embodiment are initially in three languages, English, French, and Spanish, as would be known to those skilled in the art. The specific healthcare facts for respective general healthcare classifications, may be read in one of these languages by selection of the appropriate language selection button as shown on the main page FIG. 3.

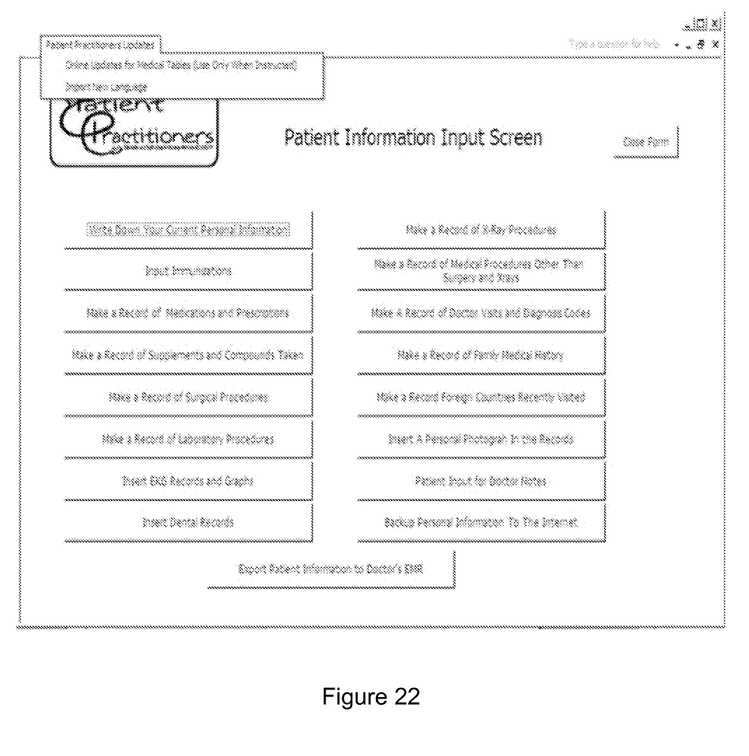

According to the inventive principles, as shown for a preferred embodiment, an additional language may be imported from a local or remote site and supported on the Host CPU 21. According to the inventive principles for a disclosed preferred embodiment, selection of another language may be made at the Patient Practitioners Internet location 37 and imported to the drive 24 and virtual portal 20, as would be known and understood by those skilled in the art. The selected new language may be imported for use with the Patient Practitioners Data Base 23, by selecting the Import New language command in the drop down menu, as shown in the Patient Information Screen, FIG. 4, as shown in detail in FIG. 22.

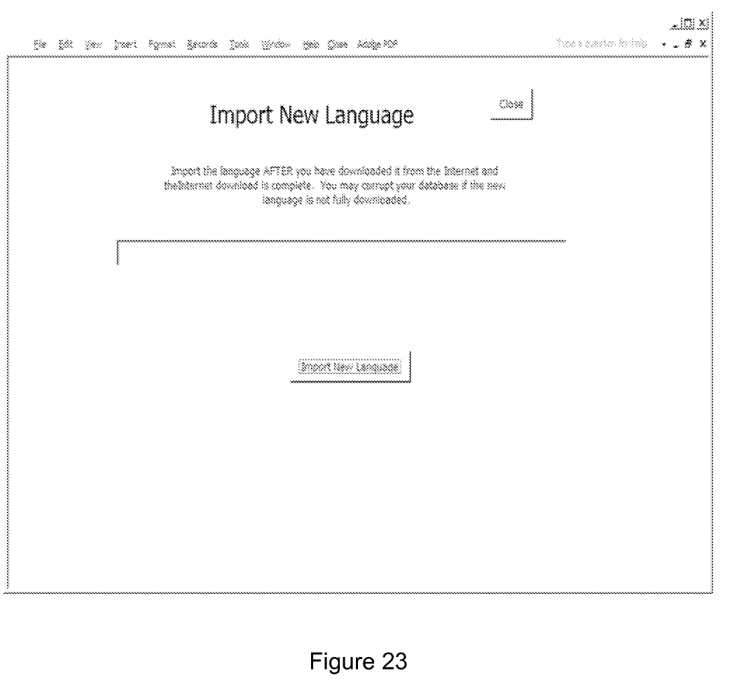

Selecting the Import New Language, using the windows display command in the drop-down menu, as shown for a preferred embodiment in FIG. 22, displays the Import New Language Screen, FIG. 23. By selection of the Import New Language button, the Patient Practitioners data base, will import the new language for use with the Patient Practitioners Data Base, and display of the healthcare data in the selected language, for the specific healthcare facts.

### Doctors Notes

According to the inventive principles, as shown for a preferred embodiment selecting the Input Doctors Notes button, in the Patient Information Input Screen, FIG. 4, will produce on the screen display 12, the Patients Doctors Notes Input Screen, FIG. 23. The doctor's notes may be entered in conjunction with the entering the Doctor's name, address, phone number, date and by entering the Doctor's Notes in the Doctor's Note box. The Doctor's Note may be transcribed the same as any word processing document or pasted in the Doctor's Note Box. Selecting the Save This Record and Enter Another, will refresh the Doctor's Note Input Screen for entry of another Doctor's Note. Selecting the I'm Done Do Something Else, will return the screen display to the Patient Input Information Input Screen FIG. 4. The entered doctor's note is stored in the Patient Practitioners Data Base 17, as would be understood by those skilled in the art.

The Patient Input for Doctor's Notes may be displayed by selecting the Patient Input to Doctor's Notes button in the Main Screen, FIG. 3. The Doctor's Notes display windows screen, as shown in FIG. 24, will be displayed on screen 12, with the data entered in the Patient Practitioners Data Base, by selecting the Save or I'm Done, button on the Patients Doctors Notes Input Screen, Doctor's Notes button in the Main Screen, FIG. 3.

### Dental Records

By selecting the Input Dental Records button on the Patient Input Screen, FIG. 4. the windows Put Dental Procedures in Your Medical Record, FIG. 11, will be displayed on screen display 12, as would be known to those skilled in the art.

As shown in a preferred embodiment in Patent Publication No. US 2007-0055550 A1, and as shown herein FIG. 11, the specific healthcare data for the General Healthcare classification for Dental Records, is entered as a specific healthcare fact bar code and respective description. The correct bar code is found by use of the first section window scroll list of all the possible dental procedures, as shown for a preferred embodiment in FIG. 11. The second window is a search box, Type Dental Procedure to Get the Bar Code, that may be used to enter the exact dental procedure name. In response, the Patient Practitioners Data Base will locate and display the corresponding bar code in the window adjacent the Type Dental Procedure to Get the Bar Code, window.

As shown for a preferred embodiment, as would be known to those skilled in the art, as the exact dental procedure is progressively typed into window, first section window scroll box will progressively move through the Patient Practitioners stored dental procedures and corresponding bar codes, until a match is found. Opposite of the name of the dental procedure will appear the bar code number for this procedure. That bar code may be entered by entering the bar code number into the box labeled ‘Bar Code Field’ and the name of the dental procedure and its bar code will appear in the data entry boxes immediately at the bottom of the screen and will be entered in the Patient Practitioners healthcare data base, upon selection of the Save This Procedure Record.

As would be apparent to those skilled in the art, the principles shown and disclosed herein for a preferred embodiment, may be varied with the same functions, and operation and results.

1. A personal portable patient healthcare data base program, comprising,
a patient data base arranged in first storage location of patient identifiable relatable records;
a data base program comprising a data input program including a data insertion display and a data output program including a data output display;
a data processor responsive to data base program said data input program and said data output program and connecting said records with said data insertion display and said data output display;
at least one of said records comprising healthcare facts for a plurality of general healthcare classifications and for respective specific healthcare facts within said general healthcare classifications;
said data base arranged in a second storage location separate from said first storage location and
said relatable records in said first storage location; and wherein said data base program comprises a data process for placing in said second storage location, separate images identified with respective general healthcare classifications.

2. The personal portable patient healthcare data base program, of claim 1, wherein said second storage location is identified by a virtual data path to an images file.

3. The A personal portable patient healthcare data base program, of claim 2, wherein said image file comprises a sub file and a sub file directory and said separate images are stored in said sub file and are identified as said separate images in said sub file directory.

4. The personal portable patient healthcare data base program, of claim 3, wherein said sub file virtual path is identified by the virtual path . . . /sub/xxx.xxx.

5. The personal portable patient healthcare data base program, fo claim 1, wherein said patient data base is within a portable storage comprising said data base and a data base executable program arranged to operate a host CPU data processor responsive to said data base program.

6. The personal portable patient healthcare data base program, of claim 1, wherein at least one said data insertion display for a respective general healthcare classification comprises a digital images screen display, displaying images for said respective general healthcare classification, said digital images screen display including a menu for displaying a plurality of commands for pasting, loading individual image files or loading batch image files or acquiring an image from a scanner or camera.

7. The personal portable patient healthcare data base program of claim 6, wherein, comprising a window displaying at least a directory for said images in said images file for said respective general healthcare classification.

8. The personal portable patient healthcare data base program, of claim 6, wherein said digital images screen comprises a window displaying images added to said images file.

9. The personal portable patient healthcare data base program, of claim 1, wherein said data insertion display comprises a digital images input screen display for the general healthcare classifications of dental records or doctors's notes.

10. A personal portable patient healthcare data base program, comprising,
a patient data base arranged in first storage location of patient identifiable relatable records;
a data base program comprising a input program comprising a data insertion display and a data output program including a data output display;
said data base program connecting said records with said data insertion display and said data output display;
at least one of said records comprising healthcare facts for a plurality of general healthcare classifications and for respective specific healthcare facts within said general healthcare classifications; and wherein,
said patient data base comprises a data base executable program arranged to operate a host CPU responsive to said data base program and to open a virtual portal for transferring said healthcare records to a remote location.

11. The personal portable patient healthcare data base program of claim 9, wherein, said data base and said data base executable program are in a portable storage, said portable storage comprising connections to said host CPU, and said data base executable program is arranged to be loaded into said host CPU when said portable store is connected to said host CPU, and said host CPU, responsive to said data base executable program opens said virtual portal.

12. The personal portable patient healthcare data base program of claim 10, wherein said virtual portal comprises a storage location, for placing data related to specific healthcare facts for export to a remote electronic medical record data base or to a central storage location, or for import of data related to specific healthcare facts, from an electronic medical record data base or said central store.

13. The personal portable healthcare data base of claim 12, wherein said data base program comprises a program for displaying said specific healthcare facts is at least two displayed languages and for importing at least one new language for displaying said specific healthcare facts in said at least one new language.

14. A personal portable patient healthcare data base program, comprising,
a patient data base arranged in patient identifiable relatable records;
a data input process including a data insertion display and a data output process including a data output display;
a data process connecting said records with said data insertion display and said data output display;
at least one of said records comprising bar coded healthcare facts for a plurality of general healthcare classifications and for respective specific healthcare facts within said general healthcare classifications;
said wherein said data process comprises a process for placing in at least one of said relatable records identified with a respective general healthcare classification, a specific healthcare fact responsive to the insertion in said data insertion display of a respective bar code for a said bar coded healthcare fact, and wherein,
said general healthcare classifications are dental records.

15. A personal portable patient healthcare data base program, comprising,
a patient data base arranged in patient identifiable relatable records;
a data input program including a data insertion display and a data output programs including a data output display;
a data base program connecting said records with said data insertion display and said data output display;
at least one of said data insertion displays are for entering specific healthcare facts of doctor's notes for the general healthcare classification of doctor's notes, and at least one of said data insertion displays are for displaying said specific healthcare facts of doctor's notes.

16. The personal portable patient healthcare data base program of claim 14, wherein said doctor's notes data insertion display comprises a window for insertion of text or images, by word processing or by loading or copying and pasting, a data file.

17. A personal portable patient healthcare data base program, comprising,
a patient data base arranged in patient identifiable relatable records;
a data input program including a data insertion display and a data output programs including a data output display;
a data base program connecting said records with said data insertion display and said data output display;
said data base program comprising a language program for display of said specific healthcare facts in at least two languages;
said language program comprising a screen display for importing at least one new language and or displaying said specific healthcare facts in said at least one new language.
